(19) United States
(12) Patent Application Publication
(10) Pub. No.: US 2025/0042231 A1
(43) Pub. Date: Feb. 6, 2025

(54) ANTI-GLARE SUNSHADE

(71) Applicant: GUANGZHOU ISSYZONE TECHNOLOGY CO.,LIMITED, Guangzhou (CN)

(72) Inventors: TAIPING YANG, Shenzhen (CN); NING WANG, Changsha (CN); GUOCHAO XU, Guangzhou (CN)

(21) Appl. No.: 18/371,639

(22) Filed: Sep. 22, 2023

(30) Foreign Application Priority Data
Aug. 3, 2023 (CN) 202322076281.6

(51) Int. Cl. B60J 3/02

(52) U.S. Cl. CPC B60J 3/0221; B60J 3/0226; B60J 3/0239

(57) ABSTRACT

The present disclosure discloses an anti-glare sunshade, which includes a slide rail, one side of the slide rail is provided with a slider, and an end of the slider is hinged with a polariscope via a first rotation mechanism. An end of one side of the slide rail facing away the slider is provided with a second rotation mechanism, and the slide rail is hinged with a clamp via a second rotation mechanism. The beneficial effect of the present disclosure is that the first rotation mechanism and the second rotation mechanism can rotate freely by providing the slide, so that a user can freely adjust a fixing position of the polariscope, thereby shielding sunlight shining from one side.

### CROSS-REFERENCE TO RELATED APPLICATIONS

This application claims the benefit and priority of Chinese patent application No. 202322076281.6, filed on Aug. 3, 2023, disclosure of which is hereby incorporated by reference in its entirety.

### TECHNICAL FIELD

The present disclosure relates to the field of car accessories technologies, and in particular, to an anti-glare sunshade.

### BACKGROUND

An anti-glare sunshade uses the principle of polariscope, and its application range is becoming increasingly wide as it does not reduce a driver's field of view. The anti-glare sunshade is not a standard configuration for a vehicle and is generally purchased by users themselves. It can only be installed on an original sunshade through clamping and fixing. When in use, a position of the original sunshade remains unchanged, and the anti-glare sunshade can be flipped down to a desired angle. For example, CN204586450U discloses an anti-glare polariscope mounted on a car sunshade, which is installed on the car sunshade through a damping gemel hinge. However, in this structure of the anti-glare sunshade, the polarizing lens can only rotate around a center of the damping gemel hinge to shield sunlight shining form front but cannot shield the sunlight shining from one side.

### SUMMARY

Regarding to the above technical problem, the present disclosure provides an anti-glare sunshade, which mainly solves the problem that existing anti-glare sunshades cannot shield sunlight shining from one side.

To solve the above technical problem, the technical solution of the present disclosure is as follows:
an anti-glare sunshade including a slide rail, one side of the slide rail is provided with a slider, an end of the slider is hinged with a polariscope via a first rotation mechanism, an end of one side of the slide rail facing away from the slider is provided with a second rotation mechanism, and the slide rail is hinged with a clamp via the second rotation mechanism.

In an embodiment, the slide rail includes an upper shell and a lower shell, where a bottom of the lower shell is provided with a sliding groove fitting with the slider along a length direction of the lower shell.

In an embodiment, the slider includes a first connecting portion provided at a lower side of the sliding groove and a limiting portion provided at an upper side of the sliding groove; a center of the first connecting portion and a center of the limiting portion are both provided with a first installation hole, and a first fastener sequentially passes through two first installation holes from the bottom.

In an embodiment, the first rotation mechanism includes a hinge and a ball head installed at one end of the hinge, a bottom of the first connecting portion is provided with a housing chamber for accommodating the ball head.

In an embodiment, a top of an inner wall of the upper shell is provided with first positioning holes that are continuous along a length direction of the upper shell, an upper end of the limiting portion is provided with a first positioning column, an interior of the first positioning column is provided with a first positioning spring, and a top of the first positioning spring is provided with a first positioning ball fitting with the first positioning hole.

In an embodiment, the second rotation mechanism includes a second connecting portion that is fixedly connected to the clamp, one end of a top of the upper shell is provided with an installation groove accommodating the second connecting portion, a bottom center of the installation groove is embedded in a first rotation portion, and a center of an outer wall of the lower shell is embedded in a second rotation portion that is coaxial with the first rotation portion; a center of the second connecting portion, a center of the first rotation portion, and a center of the second rotation portion are all provided with a second installation hole, and a second fastener sequentially passes through three second installation holes from the bottom.

In an embodiment, a bottom of the second connecting portion is provided with a second positioning hole with a circumferential portion, a top of the installation groove is provided with a second positioning column with a circumferential portion, an interior of the second positioning column is provided with a second positioning spring, and a top of the second positioning spring is provided with a second positioning ball fitting with the second positioning hole.

In an embodiment, another end of the hinge is provided with a clamping portion, and the clamping portion detachably fixes the polariscope.

The beneficial effect of the present disclosure is that a first rotation mechanism is provided at an end of the slider, and a second rotation mechanism is provided at an end of one side of the slide rail facing away from the slider. The polariscope and the clamp are hinged by the first rotation mechanism and the second rotation mechanism, respectively. When in use, a user can fix the clamp on an original sunshade, and then manually push the slide rail to one side of the window along a rotation axis of the second rotation mechanism, then flip the polariscope down along a rotation axis of the first rotation mechanism to an expected angle, and finally push the polariscope to an expected position by the slider, thereby freely adjusting a fixing position of the polariscope and shielding sunlight shining from one side.

### BRIEF DESCRIPTION OF DRAWINGS

FIG. 1 is a structural schematic diagram of an anti-glare sunshade disclosed in an embodiment of the present disclosure.

FIG. 2 is an exploded cross-sectional view of the anti-glare sunshade disclosed in an embodiment of the present disclosure.

FIG. 3 is a partially enlarged view of part Ain FIG. 2.

FIG. 4 is a partially enlarged view of part B in FIG. 2.

Numeral reference: 1—Slide rail; 2—Slider; 3—First rotation mechanism; 4—Polariscope; 5—Second rotation mechanism; 6—Clamp; 101—Upper shell; 102—Lower shell; 103—Sliding groove; 104—First positioning hole; 105—Installation groove; 201—First connecting portion; 202—Limiting portion; 203—First fastener; 204—First positioning column; 205—First positioning spring; 206—First positioning ball; 207—Housing chamber; 301—Hinge; 302—Ball head; 303—Clamping portion; 501—Second connecting portion; 502—First rotation portion; 503—Second rotation portion; 504—Second fastener; 505—Second positioning hole; 506—Second positioning column; 507—Second positioning spring; 508—Second positioning ball.

### DETAILED DESCRIPTION

In order to render the purpose, technical solution, and advantages of the present disclosure clearer and specific, the content of the present disclosure will be further detailed in conjunction with the drawings and specific embodiments. It can be understood that the specific embodiments described here are only used to explain the present disclosure, rather than limiting it. In addition, it should be noted that for the convenience of description, only some portions related to the present disclosure are shown in the drawings, rather than the entire content.

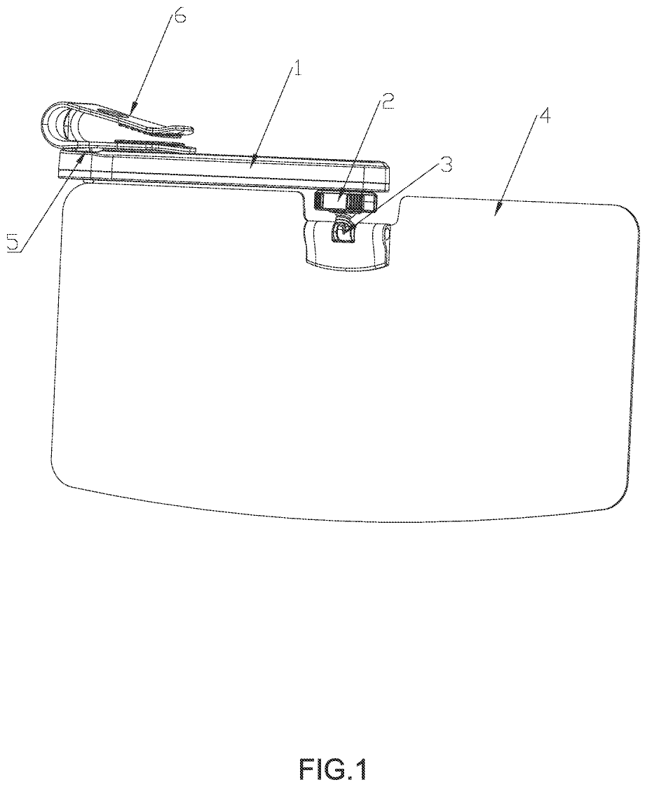

This embodiment provides an anti-glare sunshade, as shown in FIG. 1, which includes a slide rail 1. One side of slide rail 1 is provided with a slider 2, and an end of slider 2 is hinged with a polariscope 4 via a first rotation mechanism 3. An end of one side of the slide rail 1 facing away from the slider 2 is provided with a second rotation mechanism 5, and the slide rail 1 is hinged with a clamp 6 via the second rotation mechanism 5.

In this embodiment, the first rotation mechanism 3 is provided on the end of the slider 2, and the second rotation mechanism 5 is provided on the end of one side of the slide rail 1 facing away from the slider 2. The polariscope 4 and the clamp 6 are hinged using the first rotation mechanism 3 and the second rotation mechanism 5, respectively. When in use, a user can fix the clamp 6 on an original sunshade, and then manually push the slide rail 1 to one side of a window along a rotation axis of the second rotation mechanism 5, then flip the polariscope 4 down along a rotation axis of the first rotation mechanism 3 to an expected angle, and finally use the slider 2 to push the polariscope 4 to slide to an expected position, thereby freely adjusting a fixing position of the polariscope 4 and shielding sunlight shining from one side.

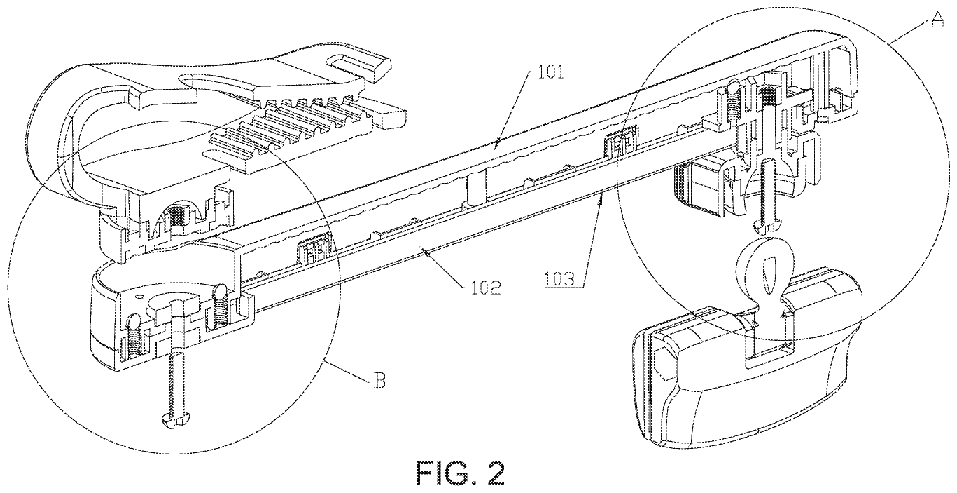

For the convenience of assembly and processing of slide rail 1, in one example, as shown in FIG. 2, the slide rail 1 includes an upper shell 101 and a lower shell 102, a bottom of the lower shell 102 is provided with a sliding groove 103 fitting with the slider 2 along a length direction of the lower shell 102.

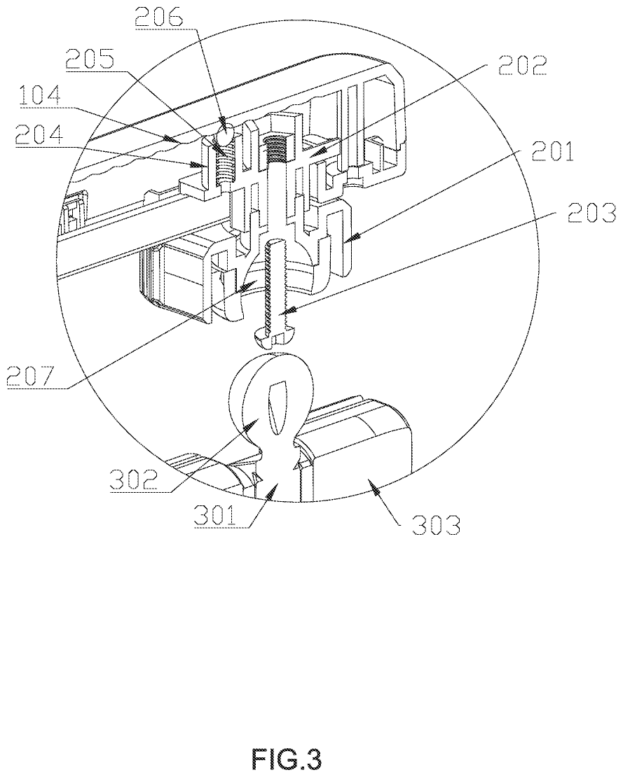

Specifically, as shown in FIG. 3, the slider 2 includes a first connecting portion 201 provided at a lower side of the sliding groove 103 and a limiting portion 202 provided at an upper side of the sliding groove 103. A center of the first connecting portion 201 and a center of the limiting portion 202 are both provided with a first installation hole (as shown in the figure but not marked), and a first fastener 203 (such as a screw connection using a screw and a nut) sequentially passes through two first installation holes from the bottom. Thus, the first connecting portion 201 and the limiting portion 202 are fixed as a whole. In this solution, the first connecting portion 201 and the limiting portion 202 are connected through the first fastener 203 to form a complete slider 2. A lower end of the limiting portion 202 abuts against an upper end of the sliding groove 103 to prevent the slider 2 from detaching from the sliding groove 103. The first connecting portion 201 serves as a connecting portion between the slider 2 and the first rotation mechanism 3.

The first rotation mechanism 3 described in this embodiment can be any structure that can provide at least one set of degrees of freedom. In one example, continue to refer to FIG. 3. The first rotation mechanism 3 includes a hinge 301 and a ball head 302 installed at one end of the hinge 301. The other end of the hinge 301 is connected to the polariscope 4, and a bottom of the first connecting portion 201 is provided with a housing chamber 207 for accommodating the ball head 302, the combination of hinge 301 and ball head 302 allows a user to adjust an angle of polariscope 4 more flexibly.

To improve the user experience, the slider 2 should have a certain self-locking function to prevent slipping during use. On the basis of the above solution, continue to refer to FIG. 3, A top of an inner wall of the upper shell 101 is provided with first positioning holes 104 that are continuous along a length direction of the upper shell 101, an upper end of the limiting portion 202 is provided with a first positioning column 204, an interior of the first positioning column 204 is provided with a first positioning spring 205, and a top of the first positioning spring 205 is provided with a first positioning ball 206 fitting with the first positioning hole 104. Based on this solution, when the user pushes the slider 2, and at this point, the first positioning ball 206 is forced to exit from the current first positioning hole 104. When the slider 2 stops moving, an elastic force provided by the first positioning spring 205 can compress the first positioning ball 206 into a new first positioning hole 104, and thereby forming a new locking relationship.

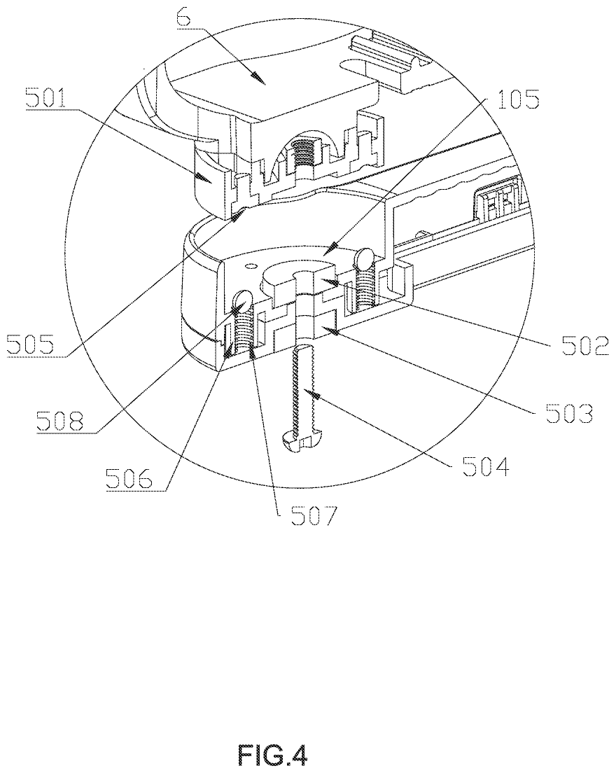

The second rotation mechanism 5 mentioned above can be any rotation mechanism, such as a bearing. In an example, as shown in FIG. 4, the second rotation mechanism 5 includes a second connecting portion 501 that is fixedly connected to the clamp 6. One end of a top of the upper shell 101 is provided with an installation groove 105 accommodating the second connecting portion 501. A bottom center of the installation groove 105 is embedded in a first rotation portion 502, a center of an outer wall of the lower shell 102 is embedded in a second rotation portion 503 that is coaxial with the first rotation portion 502; a center of the second connecting portion 501, a center of the first rotation portion 502, and a center of the second rotation portion 503 are all provided with a second installation hole (as shown in the figure, not marked), and a second fastener 504 sequentially passes through three second installation holes from the bottom in order to fix the second connecting portion 501, the first rotation portion 502, and the second rotation portion 503 as a whole. In this solution, as the clamp 6 is already fixed to the original sunshade before use, it should be considered as an immovable mechanism. On this basis, and due to the fixed relationship between the second connecting portion 501 and the clamp 6, when the user pushes slide rail 1, the second rotation mechanism 5 should also be considered as an immovable mechanism, and ultimately the slide rail 1 rotates around the second rotation mechanism 5.

The second rotation mechanism 5 should have a certain self-locking function, which can be achieved through friction locking principle or mechanical mechanism, optionally, continue to refer to FIG. 4. A bottom of the second connecting portion 501 is provided with a second positioning hole 505 with a circumferential portion, and a top of the installation groove 105 is provided with a second positioning column 506 with a circumferential portion. The second positioning column 506 can extend upwards or downwards, an interior of the second positioning column 506 is provided with a second positioning spring 507, and a top of the second positioning spring 507 is provided with a second positioning ball 508 fitting with the second positioning hole 505. This structure can refer to the first positioning ball 206 above and will not be elaborated here.

In an implementation mode, continue to refer to FIG. 3. Anther end of hinge 301 is provided with a clamping portion 303, which can disassembly fix the polariscope 4. And the clamping portion 303 can be composed of two hard sheets, and the polariscope 4 can be installed and disassembled by a mode of screw fastening.

The above embodiments are only intended to illustrate the technical concept and features of the present disclosure, and their purpose is to enable ordinary technical personnel in the field to understand the content of the present disclosure and implement it accordingly, without limiting the protection scope of the present disclosure. Any equivalent changes or modifications made based on the essence of the content of the present disclosure should be covered within the protection scope of the present disclosure.

What is claimed is:

1. An anti-glare sunshade, comprising a slide rail, one side of the slide rail is provided with a slider, and an end of the slider is hinged with a polariscope via a first rotation mechanism, an end of one side of the slide rail facing away the slider is provided with a second rotation mechanism, and the slide rail is hinged with a clamp via the second rotation mechanism.

2. The anti-glare sunshade according to claim 1, wherein, the slide rail comprises an upper shell and a lower shell, wherein a bottom of the lower shell is provided with a sliding groove fitting with the slider along a length direction of the lower shell.

3. The anti-glare sunshade according to claim 2, wherein, the slider comprises a first connecting portion provided at a lower side of the sliding groove and a limiting portion provided at an upper side of the sliding groove; a center of the first connecting portion and a center of the limiting portion are both provided with a first installation hole, and a first fastener sequentially passes through two first installation holes from the bottom.

4. The anti-glare sunshade according to claim 3, wherein, the first rotation mechanism comprises a hinge and a ball head installed at one end of the hinge, a bottom of the first connecting portion is provided with a housing chamber for accommodating the ball head.

5. The anti-glare sunshade according to claim 3, wherein, a top of an inner wall of the upper shell is provided with first positioning holes that are continuous along a length direction of the upper shell, an upper end of the limiting portion is provided with a first positioning column, an interior of the first positioning column is provided with a first positioning spring, and a top of the first positioning spring is provided with a first positioning ball fitting with the first positioning hole.

6. The anti-glare sunshade according to claim 2, wherein, the second rotation mechanism comprises a second connecting portion that is fixedly connected to the clamp, one end of a top of the upper shell is provided with an installation groove accommodating the second connecting portion, a bottom center of the installation groove is embedded in a first rotation portion, and a center of an outer wall of the lower shell is embedded in a second rotation portion that is coaxial with the first rotation portion; a center of the second connecting portion, a center of the first rotation portion, and a center of the second rotation portion are all provided with a second installation hole, and a second fastener sequentially passes through three second installation holes from the bottom.

7. The anti-glare sunshade according to claim 6, wherein, a bottom of the second connecting portion is provided with a second positioning hole with a circumferential portion, a top of the installation groove is provided with a second positioning column with a circumferential portion, an interior of the second positioning column is provided with a second positioning spring, and a top of the second positioning spring is provided with a second positioning ball fitting with the second positioning hole.

8. The anti-glare sunshade according to claim 4, wherein, another end of the hinge is provided with a clamping portion, and the clamping portion detachably fixes the polariscope.
